(19) United States
(12) Patent Application Publication
(10) Pub. No.: US 2026/0226341 A1
(43) Pub. Date: Aug. 6, 2026

(54) IONIC LIQUIDS AND USE THEREOF FOR DISSOLVING OR PREVENTING DEPOSITS, MAINLY FORMED BY SULFUR, WHICH IMPAIR PRODUCTION OF GAS WELLS

(71) Applicant: ENI S.P.A., Roma (IT)

(72) Inventors: Alberto Renato DE ANGELIS, San Donato Milanese (MI) (IT); Ivan MAFFEIS, San Donato Milanese (MI) (IT); Lorenzo GUAZZELLI, Pisa (PI) (IT); Andrea MEZZETTA, Stagno, Collesalvetti (LI) (IT)

(21) Appl. No.: 19/154,264

(22) PCT Filed: Feb. 16, 2024
(86) PCT No.: PCT/IB2024/051484

§ 371 Date: Aug. 6, 2025

(30) Foreign Application Priority Data
Feb. 17, 2023 (IT) 102023000002718

(51) Int. Cl. C09K 8/532

(52) U.S. Cl. CPC C09K 8/532

(57) ABSTRACT

A solvent composition is described capable of dissolving deposits, formed mainly by elemental sulfur, present in a drilling and/or extraction well for natural gas, but also capable of preventing the formation of said deposits, the composition having at least one ionic liquid including
at least one anion and
at least one cation.

The anion of the at least one ionic liquid includes an aliphatic radical R and a carboxylate group bonded to the aliphatic radical R (anion RCOO—), the aliphatic radical R having a number of carbon atoms ranging from 1 to 26, the aliphatic radical R also containing at least one thiol group —SH as a substituent of H atom or of a methyl group contained in the aliphatic radical R.

### CROSS-REFERENCE TO RELATED APPLICATIONS

This application is a 35 U.S.C. § 371 National Stage patent application of PCT/IB2024/051484, filed on 16 Feb. 2024, which claims the benefit of Italian patent application 102023000002718, filed on 17 Feb. 2023, the disclosures of which are incorporated herein by reference in their entirety.

### TECHNICAL FIELD

The present disclosure relates to ionic compounds, preferably liquids, consisting of at least one cation and at least one anion, wherein the anion is an ion including a carboxylate group and a thiol group in a specific position with respect to the carboxylate group.

In particular, the present disclosure relates to the use of one or more of said ionic liquids, possibly in a mixture with at least one polar aprotic liquid, as a solvent or solvent system for dissolving sulfur deposits in drilling and/or extraction wells for natural gas, or for hydrocarbons in which the natural gas fraction is present as an associated gas, (hereinafter also referred to collectively as “gas wells” for the sake of brevity) in order to dissolve elemental sulfur (i.e., sulfur not bonded to atoms other than sulfur) that has been deposited on one or more components of said well, e.g., pipes, bearings, in contact with said natural gas during its extraction (sulfur deposition; sulfur precipitation; sulfur scaling), due to the operating conditions of the well.

### BACKGROUND

The precipitation of elemental sulfur (which is an apolar compound and has a melting point of around 119° C. at atmospheric pressure) in a natural gas extraction drilling well is mainly due to variations in the physical parameters of the gas in the well such as, for example, temperature and pressure; or it is due to chemical phenomena, such as, for example, the entry of water into the well, interactions with the metal surfaces of the well components, thus leading to the formation, on the well components, of deposits consisting mainly of elemental sulfur.

In particular, H₂S acid, which is always present in natural gas, can, in the presence of even small deposits of elemental sulfur, lead to a reaction of sulfane formation, which, as it degrades, goes on to form further elemental sulfur that is deposited, with very fast kinetics, on the surfaces of the well components.

Another possible mechanism for the formation of elemental sulfur deposits is due to the presence of sulfur in metastable form in natural gas.

As can be easily deduced, the formation of sulfur deposits is a problem in natural gas extraction wells, or hydrocarbon wells where the natural gas fraction is present as associated gas, as it is necessary to interrupt the extraction of the fluid in order to intervene and remove these deposits from the well components, e.g. the equipment, e.g. bearings, and/or the structures in the well, e.g. the moving mechanical equipment that extracts the fluid.

For example, in the case of deposits on the extraction or transport pipeline of the fluid (e.g. natural gas), these deposits quickly reduce, e.g. in 48 hours, the fluid passage section through the duct.

Currently, aromatic solvents, mainly toluene (an aprotic compound which is slightly polar), are commonly used for the dissolution of such sulfur deposits that make the operational management of the sulfur dissolution process complicated, also in light of the fact that sulfur dissolution is not a spontaneous but an endothermic phenomenon.

In particular, toluene, while economically viable for such industrial applications, is toxic, flammable and has a boiling point of around 110° C. (at atmospheric pressure), which could be the temperature of the sulfur deposits in the well: given its high volatility at well temperatures, toluene must be used operating at high pressures to remain liquid, which increases the risk of explosions and/or fires, given its high flammability.

In addition, at the operating temperatures of the drilling and/or extraction well, toluene exhibits moderate solubility (grams, moles or solute equivalents with respect to the mass or volume unit of the solvent at a given temperature and pressure) with respect to elemental sulfur, which is less than 10 g of sulfur with respect to 100 g of toluene (solubility less than 10 wt %) at atmospheric pressure and well temperatures (80-110° C.). See comparison example.

Therefore, it would be highly desirable to find an alternative or even improved elemental sulfur dissolution solvent or solvent system to be used for the dissolution of elemental sulfur deposits in gas wells (natural gas or hydrocarbon extraction wells), which does not have the disadvantages of the solvents hitherto used industrially for the dissolution of elemental sulfur deposits in gas wells (i.e. flammability, high volatility, moderate solubility), and which is also cheap and easy to manufacture so that it can be used in the removal of sulfur deposits in gas wells.

In addition, it would also be highly desirable to have a method available that would prevent deposits mainly consisting of sulfur from forming in gas wells so as to avoid interrupting well production in order to carry out the removal of these deposits.

Patent application US2014/216748 A1 discloses the use of a composition to dissolve mineral scale during the extraction of hydrocarbons, said composition comprising a cationic surfactant and a corrosion inhibitor which can be thioglycolate (mercaptopropionate) is provided: the scale deposits to be removed are mineral salt deposits, e.g. calcium carbonate, which are polar substances known to be different from the elemental sulfur which is apolar.

### SUMMARY

The Applicant has now unexpectedly found that a specific class of ionic compounds, primarily in liquid form (i.e., ionic liquids), comprising at least one specific anion and at least one cation, is capable of solving the aforementioned technical problems in that it is capable of acting as dissolution solvent of elemental sulfur and of dissolving elemental sulfur deposits in gas wells and/or preventing the formation of said deposits, due to the presence in said anion of at least one carboxylate group and at least one sulfanyl (thiol) group as a substituent in a specific position with respect to said carboxylate group.

The characteristics of the ionic compounds of the present disclosure which act as dissolution solvent of elemental sulfur, and methods of use thereof for the removal and prevention of sulfur deposits are set out in the accompanying independent claims.

Accordingly, it is a first aspect of the present disclosure to provide a dissolving composition (also referred to as a dissolution solvent system) capable of dissolving deposits consisting primarily of elemental sulfur present in a drilling and/or extraction well of natural gas, or of hydrocarbons in which the natural gas fraction is present as associated gas, said dissolving composition comprising a dissolution solvent of elemental sulfur, optionally in admixture with at least one polar aprotic solvent, wherein said solvent of dissolution is at least one ionic compound, or a mixture of ionic compounds, each ionic compound consisting of
at least one anion, and
at least one cation
wherein said at least one anion of each ionic compound comprises an aliphatic radical R and at least one carboxylate group bonded to said aliphatic radical R (anion RCOO—),
said aliphatic radical R having a number of carbon atoms ranging from 1 to 26,
said aliphatic radical R also containing at least one thiol group —SH as a substituent of H atom or of a methyl group contained in said aliphatic radical R.

In an embodiment, said at least one thiol group which is contained in said at least one anion is in position 2, 3 or 4 with respect to said at least one carboxylate group.

In a preferred embodiment, said at least one thiol group of said at least one anion is in position 2 or 3 with respect to the carboxylate group, preferably in position 2.

It is understood that two or more thiol groups may also be present in the anion of each ionic compound defined above in accordance with the present disclosure, without departing from the scope and/or field of protection of the present disclosure.

It is also to be understood that if two or more ionic compounds as defined above in accordance with the disclosure are present in the dissolving composition of the present disclosure, the thiol group of an ionic compound may be present in a position 2,3, 4 which is different from the position 2,3,4 of the thiol of another ionic compound in accordance with the disclosure, without departing from the scope and/or field of the present disclosure.

It is further understood that more than one carboxylate group may be present in the anion of each ionic compound defined above in accordance with the present disclosure, without departing from the scope and/or purpose of the present disclosure.

In the present description of the disclosure, unless otherwise specified, the values of the ranges include the extremes of the range.

In the present description of the disclosure, unless otherwise specified, the percentages (%) are to be understood by weight.

In the present description of the disclosure, the term “comprise” includes as a particular limiting case also its meaning as “consisting of”.

In the present description of the disclosure, the term “essentially consists of” means that
the composition or method necessarily includes the listed ingredients or steps;
   and that
the composition or method is open to unlisted ingredients or steps that do not materially affect the basic and innovative properties of the composition or method.

In the present description of the disclosure, unless otherwise specified, “part” and “parts” means part by weight and parts by weight, respectively.

In accordance with the present disclosure, the singular indefinite article, one, is understood to include also the meaning of at least one, unless otherwise specified.

In the present description of the disclosure, the term “deposits consisting mainly of elemental sulfur” is used indistinctly to define:
deposits of pure elemental sulfur consisting of orthorhombic or monoclinic sulfur in the usual form S8, although other allotropic forms of sulfur such as S6 or S7 may be present in small quantities;
deposits of elemental sulfur which is not pure inasmuch as it also contains impurities such as, for example, carbon-sulfur compounds known in the literature as Carsul and/or an organic component such as hydrocarbons, in particular polycyclic aromatic hydrocarbons such as, for example, alkyl naphthalenes: generally, the quantity of such impurities, in particular the said hydrocarbons, is less than 5% by weight with respect to the weight of the deposit, although this content may be comprised between 5% and 20% by weight without thereby departing from the scope and/or field of the present disclosure.

In this description, the term “sulfur deposits” will be used for brevity to identify both deposits consisting of pure sulfur and deposits consisting mainly of sulfur and containing other impurities as specified above.

In this description, the term “natural gas” is used to identify gas as present in a reservoir, said reservoir being either a gas reservoir or a hydrocarbon reservoir in which the fraction of natural gas is present as associated gas.

This “natural gas” may also contain acidic components such as CO₂ and H₂S: if the H₂S content exceeds 5% by volume, with respect to the total volume of the gas, the H₂S is referred to as “sour gas”, while if the H₂S content exceeds 30% by volume, it is referred to as “super sour gas”.

### DETAILED DESCRIPTION OF THE DISCLOSURE

An illustrative but not limiting example of sulfur deposits consisting mainly of elemental sulfur are deposits in which sulfur is at least 99% by weight while the remaining part to 100% is hydrocarbons.

It is understood that the dissolving composition of the present disclosure may dissolve sulfur deposits (solid sulfur) in which the sulfur content is less than 99%, e.g. 80% with the remaining part to 100% being hydrocarbons, without thereby departing from the scope and/or field of protection of the present disclosure.

The dissolving composition of the present disclosure is preferably in liquid form at well temperatures of 80-120° C., although this is not binding for the purposes of the present disclosure.

In a preferred embodiment, this composition is in liquid form at room temperature, e.g. 20-25° C., and atmospheric pressure, as well as being liquid at the well temperatures, generally around 80-120° C.

Each ionic compound as defined above that may be present in the dissolving composition of the present disclosure may be in solid, semi-solid or liquid form at room temperature and ambient pressure, preferably in a liquid state under ambient condition.

It is understood that if several ionic compounds as defined above are present in the dissolving composition of the present disclosure, they may be present in the dissolving composition of the present disclosure in the form of liquids, solids or semi-solids, indifferently from one another, without departing from the scope and/or field of protection of the present disclosure.

In the case of ionic compounds that are solid at room temperature, it is preferable for the ionic compound to have a melting point below 100° C. at ambient pressure and above 30° C.: in this case, the dissolving composition of the disclosure formed by one or more of these ionic compounds will melt near the sulfur deposit.

In one embodiment, at least one of the ionic compounds contained in the dissolving composition of the present disclosure is in liquid form at well temperatures, generally around 80-120° C.

With reference to the anion of one or more of the ionic compounds defined above, in one embodiment said radical R is selected from the group formed by:
an aromatic group, e.g. a benzene ring, e.g. phenyl;
an alkyl benzene group containing one or more alkyl groups, identical or different from each other, each containing from 1 to 10 carbon atoms (C1-C10), e.g. benzyl, tolyl;
a naphthalene group, e.g. naphthyl, or an alkylnaphthalene group containing one or more alkyl groups, identical or different from each other, each containing from 1 to 10 carbon atoms (C1-C10), e.g. methylnaphthalene;
an alicyclic group, e.g. cycloalkane, containing from 4 to 15 carbon atoms;
a C1-C10 alkyl radical.

It is understood that aromatic groups other than those described above may be used as a radical R in the anion of one or more ionic compounds according to the disclosure without departing from the scope of the present disclosure.

In an embodiment, R is a C₁-C₁₀ alkyl radical, preferably a C₁-C₄ alkyl radical.

In another embodiment, said radical R is a benzene ring and said thiol group is a substituent in position 2, 3 or 4 with respect to the carboxylate group on said benzene ring, preferably in position 2 or 3, more preferably in position 2, with respect to said carboxylate group.

In another embodiment, said radical R is a C₁-C₄ alkyl radical and said thiol group is a substituent in position 2, 3 or 4 with respect to the carboxylate group, preferably in position 2 or 3, more preferably in position 2 with respect to the carboxylate group.

Preferred examples of RCOO⁻ anion according to the present disclosure are thiosalicylate anion, 2-mercaptopropionate, 3-mercaptopropionate, anion of 2-mercaptoacetic (thioglycolic) acid, 3-mercaptobenzoate, 4-mercaptobenzoate.

Examples of cations of ionic compounds according to the present disclosure include cations of ionic liquids already known in the art such as, for example, cations based on heterocyclic compounds such as, for example, imidazolium compounds, pyridinium, pyrazolium, thiazolium, isothiazolinium, azatiazolium, oxothiazolium, dithiazolium, triazolium, thiophenium, indolium, pyrimidinium, pyrazinium, pyridazinium, piperazinium, piperidinium, morpholinium, pyranium, pyrrolidinium and the like; preferably cations based on imidazolium compounds or on pyridinium compounds or mixture thereof.

In a preferred embodiment, the cation is selected from 1-butyl-3-methylimidazolium (BMIM) and N-decylpyridinium.

In one embodiment of said ionic compound according to the disclosure, said at least one RCOO— anion of said ionic compound is selected from thiosalicylate, 2-mercaptopropionate, 3-mercaptopropionate, anion of 2-mercaptoacetic (thioglycolic) acid, 3-mercaptobenzoate, 4-mercaptobenzoate and said at least one cation of said ionic compound is selected from 1-butyl-3-methylimidazolium (BMIM), N-decylpyridinium.

Preferred examples of ionic compounds according to the present disclosure are ionic liquids, in particular the following ionic liquids:
(A) 1-butyl-3-methylimidazolium (BMIM) in combination with 2-mercaptopropionate, of formula

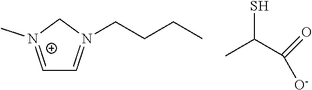

(B) N-decylpyridinium in combination with thiosalicylate, of formula

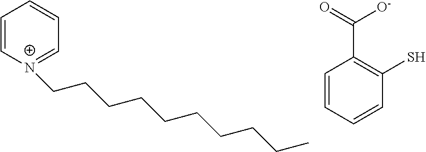 [SMILES: CCCCCCCCCC[n+]1ccccc1 ; O=C([O-])c1ccccc1S]

(C) 1-butyl-3-methylimidazolium (BMIM) in combination with thiosalicylate, of formula

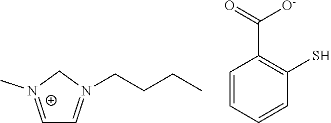

(D) 1-butyl-3-methylimidazolium (BMIM) in combination with anion of 2-mercaptoacetic acid (thioglycolic acid), of formula

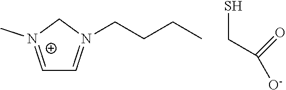

(E) 1-butyl-3-methylimidazolium (BMIM) in combination with 3-mercaptobenzoate, of formula

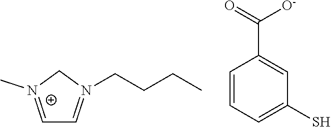

(F) 1-butyl-3-methylimidazolium (BMIM) in combination with 4-mercaptobenzoate

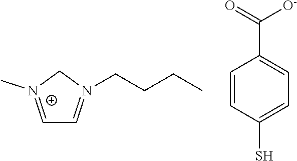

(G) 1-butyl-3-methylimidazolium (BMIM) and 3-mercaptopropionate

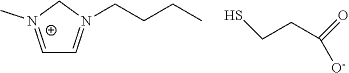

(H) one or more combinations of ionic liquids (A) to (G).

With the term “ionic liquids” it is herein intended to identify salts, generally organic salts, which have melting points lower than the boiling point of water at standard conditions (i.e. 100° C.).

A preferred class of ionic liquids is the one denominated as RTIL (Room Temperature Ionic Liquids), i.e. ionic liquids that are liquid at ambient conditions (or near ambient conditions), i.e. 25° C. and 1 bar.

The ionic liquids are constituted of ionic couples wherein an ionic couple is composed of both a cation and an anion.

In a preferred embodiment, the dissolving composition of the disclosure comprises at least an ionic liquid (A) consisting of BMIM and 2-mercaptopropionate anion, or consists of said ionic liquid (A).

In another preferred embodiment, the dissolving composition of the disclosure comprises at least one ionic liquid (D) consisting of BMIM and the anion of 2-mercaptoacetic acid or consists of said ionic liquid (D).

The dissolving compositions which consist of, or comprise, one or more ionic compounds according to the present disclosure are particularly advantageous in that they have shown a high capacity to dissolve elemental sulfur, particularly at the operating temperatures of a gas well, e.g. 80-110° C. at which the elemental sulfur is in solid form: at these well temperatures, such compositions of the present disclosure have in fact shown a solubility (understood as g of elemental sulfur with respect to 100 g of solvent) of at least 5% by weight at 80° C., and in many cases even far greater than the upper limit of 10% by weight of conventional toluene.

In particular, the dissolving compositions of the present disclosure have advantageously shown a solubility at well temperatures greater than, for example, 20%, preferably greater than 30% by weight, more preferably around 50-70% by weight with respect to the weight of the ionic liquid or the dissolving composition comprising said ionic liquid.

It is understood that the ionic compounds and the related dissolving compositions of the present disclosure can also be used to dissolve elemental sulfur in gas wells operating at temperatures below 80° C. without departing from the purpose and/or scope of protection of the present disclosure, by choosing for such use at temperatures below 80° C. the most suitable ionic compound which exhibits at 80° C. a very high solubility of elemental sulfur, for example greater than 20% by weight with respect to the weight of the ionic liquid or the dissolving composition.

Preferred examples of ionic compounds that can be used advantageously in wells at temperatures below 80° C. are those containing the following anions: 3-mercaptobenzoate, 3-mercaptopropionate, anion of 2-mercaptoacetic acid, thiosalicylate, 2-mercaptopropionate, the cation advantageously being BMIM (1-butyl-3-methylimidazolium) or N-decylpyridinium.

Further advantages of ionic compounds according to the present disclosure are as follows:
negligible vapour pressure under operating temperature conditions in gas wells: it is well known that liquid compounds formed by salts (anion+cation), i.e. ionic liquids, are high-boiling point compounds with a very low vapour pressure, in the order of millionths of a bar;
non-flammability: it is known that liquid compounds formed by salts (anion+cation), i.e. ionic liquids, are not flammable because they are stable in an oxidising environment;
are not toxic: it is known from literature that —SH groups are hepatoprotective.

Currently, to the best of the Applicant's knowledge, there are no solvents for dissolving sulfur deposits in gas wells that have the above mentioned properties of the ionic compounds according to the present disclosure, i.e. that have a negligible vapour pressure under operating temperature conditions, are non-flammable, non-toxic and have a high sulfur dissolving capacity, i.e. solubility ≥5% by weight of sulfur to the weight of the solvent, preferably solubility >20% by weight of sulfur to the weight of the solvent at well temperatures, e.g. 80° C.

Moreover, the above ionic compounds or ionic liquids have a considerable dipole moment (polarity) and far more than 0,4 Debye, which allow them to easily dissolve polar substances rather than dissolving apolar substances: thus, it has been unexpected the capacity of said ionic compounds or ionic liquids to dissolve the elemental sulfur since said elemental sulfur is an apolar substance.

The ionic compound or ionic compounds according to the present disclosure may then either constitute the dissolving composition of the present disclosure or be comprised in the dissolving composition of the present disclosure: in the latter case, the ionic compound or ionic compounds of the disclosure may be in a mixture with one or more specific polar aprotic solvents, generally high boiling point liquids, as will be detailed below.

In an embodiment of the disclosure, the content of the ionic compound, or mixture of ionic compounds as defined above, in the dissolving composition of the present disclosure may vary from 99.5% to 30% by weight of ionic compound or mixture of ionic compounds, the remaining part by weight to 100 (70%-0.5%) being represented by an aprotic polar solvent or mixture of aprotic polar solvents as defined below.

In a preferred embodiment, the content of ionic compound(s), preferably liquid(s), in the dissolving composition of the present disclosure is around 40-60% by weight, preferably around 50% by weight, the remaining part to 100 being represented by an aprotic polar solvent or a mixture of aprotic polar solvents as defined below.

It is understood that values of less than 40% and more than 60% of aprotic polar solvent, or mixture of aprotic polar solvents, may be used in the present dissolving composition without departing from the scope of the present disclosure.

Polar aprotic solvents that can be advantageously used in the dissolving composition of the present disclosure in a mixture with one or more of the ionic compounds as defined above have one or more of the following chemical and physical characteristics:
a dielectric constant s at 25° C. greater than or equal to 30;
a dynamic viscosity p at 25° C. less than or equal to 14 cP; preferably less than or equal to 12 cP;
a boiling point at normal pressure greater than or equal to 130° C. (hereafter also referred to as high-boiling point liquids).

Examples of polar aprotic solvents are dimethylsulfoxide (DMSO), sulfolane, DMI (1,3-dimethyl-2-imidazolidinone), DMPU (1,3-dimethyl-3,4,5,6-tetrahydro-2(1H)-pyrimidinone) 3-butylmethyl-imidazolium-bistrifluorosulfonylimide or other imidazole salts of bistrifluorimide, tetrathiophene oxide and HMPA (hexamethylphosphoramide), or mixtures thereof.

Preferably, the polar aprotic solvent is chosen from DMSO, sulfolane, DMPU (1,3-dimethyl-3,4,5,6-tetrahydro-2(1H)-pyrimidinone), 3-butylmethyl-imidazolium-bistrifluorosulphonylimide or other imidazole salts of bistrifluorimide, tetrathiophene oxide and HMPA (hexamethylphosphoramide), or combinations thereof.

Other possible preferred aprotic polar solvents are “green” solvents such as Cyrene™ (dihydrolevoglucosenone), Cygnet0.0™ (ethylene glycol-protected ketone deriving from levoglucosenone), dimethyl-isosorbide or Polarclean™ (Methyl-5-(dimethylamino)-2-methyl-5-oxopentanoate), or mixtures thereof.

Particularly preferred are sulfolane, Cyrene™, Cygnet0.0™, dimethyl-isosorbide, Polarclean™ or combinations thereof.

In an embodiment, the preferred solvent is sulfolane.

It should be noted that such polar aprotic solvents are not solvents used in the art in hydrocarbon extraction as elemental sulfur solvents capable of dissolving elemental sulfur deposits. The use of polar aprotic solvents described above can be particularly advantageous:
to reduce the cost of the dissolving composition of the disclosure if the one or more ionic compounds in the dissolving composition exhibit very high sulfur solubility at the well temperatures; and/or
when it is necessary to reduce the viscosity of the dissolving composition of the present disclosure so that it can be pumped into the well with less energy consumption and/or to reduce the production cost of the dissolving composition according to the present disclosure. This is possible due to the low dynamic viscosity p at 25° C. of such polar aprotic solvents, generally less than or equal to 14 cP.

The use of at least one polar aprotic solvent in the dissolving composition of the present disclosure may also be advantageous for dissolving a possible organic component of the sulfur deposit represented mainly by hydrocarbons, e.g. polycyclic aromatic hydrocarbons, when present in amounts generally varying between 5% and 20% by weight with respect to the total weight of the deposit.

The Applicant has, however, unexpectedly also found that the presence of polar aprotic solvent in the dissolving composition containing an ionic compound as defined above results in an unexpected synergistic effect in the solubilisation of sulfur, particularly unexpected in light of the fact that the polar aprotic solvents defined above are not conventionally used as sulfur solvents as such and that when used as such they solubilise elemental sulfur poorly. See the solubility data of the comparative examples.

The dissolving composition of the disclosure comprising one or more ionic compounds according to the present disclosure can be obtained, for example, from the preparation of the at least one ionic compound according to the disclosure.

Said ionic compound can be prepared using known methods of synthesis of anions and cations, in particular by metathesis reaction between salts in solvent, for example between a first salt containing said cation of said ionic compound and a second salt containing said anion of said ionic compound, in particular by metathesis reaction between
a first reactant composed of a salt containing the chosen type of cation, or an ester containing the chosen cation, of said ionic compound, e.g. carbonate, chloride, methyl carbonate, and
a second reactant composed of the acid or salt containing the chosen carboxylate anion RCOO⁻ which contains the —SH group as a substituent, e.g. thiosalicylic acid, mercaptopropionic acid, sodium thiosalicylate, thioglycolate, mercaptobenzoic acid, generally operating with equimolar ratios between the two reactants, in a medium (carrier), usually a solvent for both reactants, e.g. methanol, water.

The metathesis reaction is generally conducted at room temperature and pressure, preferably under agitation, and the solvent used is then evaporated.

The dissolving composition according to the present disclosure can be used by sending it into the gas well so as to place the sulfur deposits in contact with the dissolving composition at least until the dissolution of said deposits.

It is therefore another aspect of the present disclosure to provide a method of removing deposits, consisting primarily of elemental sulfur, from a natural gas drilling and/or extraction well, or hydrocarbon wells in which said natural gas is a fraction present as associated gas (hereinafter also referred to as gas wells for brevity), said removal method comprising
at least one step of dissolving said deposits comprising mainly elemental sulfur by contacting said deposits with a dissolving composition of the disclosure comprising at least one ionic compound as defined above.

Said removal method is generally carried out when the drilling and/or extraction well for natural gas, or hydrocarbons in which said natural gas is a fraction present as associated gas, is not in operation (well stopped) due to the occlusion of said gas well due to the formation of elemental sulfur deposits.

In particular, said dissolution step comprises the following steps of
A) feeding said drilling and/or extraction well of natural gas, or of hydrocarbons wherein said natural gas is a fraction present as associated gas, with said dissolving composition in accordance with the disclosure, preferably in liquid form, comprising said at least one ionic compound as defined above in accordance with the present disclosure.

After the dissolution step by feeding the dissolving composition into the well, a subsequent step may be provided of
B) extraction from said well of said composition, comprising further, in dissolved form, deposits consisting mainly of elemental sulfur.

In an embodiment, the present method of removing sulfur deposits, after the extraction step from the well of the dissolving composition containing dissolved sulfur (step B)), provides for a step of
C) cooling down to room temperature said composition extracted in step B) comprising said at least one ionic compound as defined above and containing in dissolved form deposits formed mainly by elemental sulfur, so as to cause precipitation of the elemental sulfur dissolved in said composition extracted in said step B).

In an embodiment, the present removal method provides, after the step of cooling said extracted composition comprising dissolved elemental sulfur (step C)) or immediately after the extraction step from the well of the composition comprising dissolved elemental sulfur (phase B)), a step of
D) separating said elemental sulfur from said composition extracted in said step B) or cooled in said step C).

In a preferred embodiment, the separation step D) takes place after the cooling step C) by separating the elemental sulfur, which is precipitated in step C), from said composition cooled in said step C).

The dissolving composition according to the present disclosure, preferably in liquid form, which is fed into step A) of the present removal process may also contain, as mentioned above, at least one suitable polar aprotic solvent as defined above, generally in liquid form, also at well temperatures.

The use of the aforementioned at least one aprotic polar solvent in combination with the at least one ionic compound as defined above in accordance with the present disclosure is particularly advantageous not only to reduce the use of ionic compound, which is generally more expensive than said solvent, but also when, as mentioned above, the sulfur deposit to be removed contains significant amounts of hydrocarbons, generally between 5% and 20% by weight of the total weight of the deposit.

In step A) of the removal process according to the present disclosure, the feeding of the dissolution solvent composition of the present disclosure may take place
by means of a pump or other liquid handling means suitable for injecting, pumping liquids into a gas well if the dissolving composition to be fed is liquid (i.e. by injection/pumping the dissolution solvent composition in liquid form);
by means of handling solids or semi-solids if the dissolving composition to be fed into the well is solid or semi-solid.

The amount of the ionic compound of the present disclosure, or mixture of ionic compounds according to the disclosure, which is fed into the gas well to remove elemental sulfur deposits depends:
on the thickness of said deposit and the dissolving capacity of the ionic compound or mixture of ionic compounds covered by the present disclosure, or the solubility of the sulfur in such ionic compounds; and/or,
on the local temperature of the well or production tube where the sulfur deposits were formed.

In fact, the higher the local temperature at which the dissolving composition is found, the greater the dissolving capacity of the ionic compounds defined above and the smaller the quantity of one or more of the ionic compounds of the disclosure required to dissolve the deposits.

Therefore, step A) of feeding the dissolving composition of the disclosure is carried out until the deposits are dissolved, in particular for such a time and/or with such an amount of dissolving composition as to be sufficient to remove the deposits by dissolution thereof.

In fact, on the basis of simple tests in field, it is possible to know the solubility of elemental sulfur deposits in a prefixed well for a defined dissolving composition and on the basis of said solubility it is possible to choose the feed flow rate of the dissolving composition that is necessary to dissolve the sulfur deposits in a prefixed time lapse.

The amount of sulfur dissolved by the dissolving composition according to the disclosure (solubility of sulfur) is at least 5% by weight of sulfur, preferably at least equal with respect to the weight of the solvent (i.e. ionic compound or mixture of ionic compounds or dissolving composition if it also contains aprotic polar solvent), at a temperature of 80° C.

Moreover, at 120° C., the amount of sulfur dissolved by the dissolving composition can be as much as 5 wt % higher than the weight of the ionic compound(s) forming the dissolving composition, even reaching over 100 wt %.

In step B) of the removal process according to the disclosure, the extraction of the liquid dissolving composition containing, in dissolved form, elemental sulfur deposits may be carried out by means of suitable means for drawing liquids from a well, e.g., suction pumps, or by means of one or more submersible pumps.

In step C) of the removal process according to the disclosure, the cooling of the liquid dissolving composition containing elemental sulfur deposits, in dissolved form, can occur naturally or by heat exchange with a fluid in a heat exchanger, or by other methods known in the art for cooling.

In step D) of the removal process according to the disclosure, the separation of the precipitated elemental sulfur from the composition obtained in step C) above may be effected by means of filtration or other separation methods known in the art, e.g. centrifugation, decantation.

As mentioned above, the composition for dissolving sulfur deposits according to the present disclosure can also be used to prevent the formation of such sulfur deposits in gas wells during gas or hydrocarbon extraction.

It is therefore a further aspect of the present disclosure to provide a method for preventing sulfur precipitation and/or the formation of deposits consisting primarily of elemental sulfur in a natural gas drilling and/or extraction well, or hydrocarbon wells in which said natural gas is a fraction present as associated gas (hereinafter also referred to as gas wells for brevity), said prevention method comprising at least a step of
bringing into contact, during the extraction of said natural gas or said hydrocarbons, one or more components of said well which are housed in said well or form said well with a dissolving composition of the disclosure comprising at least one ionic compound as defined above.

The elements/components of the well or forming the well that are to be placed in contact with the dissolving composition of the disclosure are those that are in prolonged contact with the natural gas or hydrocarbons during their extraction, e.g., piping, tubing, bearings, pumps, dampers, walls of the extraction conduit and the like, i.e., the components/elements of the well that are housed/contained therein.

In particular, the aforementioned contact step between the dissolving composition of the disclosure and the elements/components of said gas well can advantageously take place:
A) by carrying out a continuous flushing of the internal and/or external surface of one or more of said components of said well, by continuously injecting an elemental sulfur dissolving composition, said dissolving composition, in liquid form, comprising at least one ionic compound as defined above, possibly in a mixture with at least one specific aprotic polar solvent as defined above.

In the aforementioned method of preventing elemental sulfur deposits, it is not necessary to extract the dissolving composition used during flushing from the well because the quantity used for flushing is far less than that used for removing the sulfur deposits already formed and present in the well.

Therefore, in the present prevention method, it is possible to leave the dissolving composition that has been injected/flushed at the bottom of the extraction well, without having to resort to any step of extracting this composition from the well.

In accordance with the present disclosure described herein, it is therefore possible to use the at least one ionic compound of the present disclosure, as such or in a mixture with the at least one suitable high boiling-point aprotic polar solvent as defined above, either to dissolve high amounts of sulfur deposits that have blocked well production, or to prevent sulfur precipitation in extraction wells where sulfur precipitation has previously occurred or where it is reasonably assumed that given the characteristics of the well, sulfur precipitation may occur.

Some illustrative but not limiting examples of the present disclosure follow.

### EXAMPLES

In the sulfur dissolution tests shown in the following examples, commercial sulfur by Sigma Aldrich, article 13825-1KG, >99% purity, was used, with the exception of the dissolution test with real sample.

### Examples 1-7: Preparation of Ionic Liquids According to the Disclosure

### Example 1

Synthesis of Ionic Liquid (C) Consisting of 1-butyl-3-methylimidazolium (BMIM) and thiosalicylate

257.6 g of a 28.45 wt % solution in methanol of 1-butyl-3-methylimidazolium methylcarbonate equal to 73.3 g of pure 1-butyl-3-methylimidazolium methylcarbonate (0.342 moles) is loaded into a 1-litre glass flask, to which 52.7 g of thiosalicylic acid (0.342 moles) is added.

The working temperature is room temperature, around 20-25° C. The working pressure is atmospheric.

During the addition of thiosalicylic acid (2-mercaptobenzoic acid), the development of CO₂ due to the decomposition of the methylcarbonate anion is observed.

At the end of the addition, stirring continues for a further 15 minutes, then the methanol is evaporated in a rotavapor at reduced pressure (equal to 24 torr) to obtain 100 g of pure 1-butyl-3-methylimidazolium thiosalicylate as a colourless liquid, with a yield equal to 99% of the theoretical yield.

### Example 2

Synthesis of Ionic Liquid (A) Consisting of 1-butyl-3-methylimidazolium (BMIM) and 2-mercaptopropionate

308.2 g of a 28.45 wt % solution in methanol of 1-butyl-3-methylimidazolium methylcarbonate equal to 87.7 g of pure 1-butyl-3-methylimidazolium methylcarbonate (0.409 moles) is loaded into a 1-litre glass flask, to which 43.4 g of 2-mercaptopropionic acid (0.409 moles) is added.

The working temperature is room temperature, around 20-25° C. The working pressure is atmospheric.

During the addition of 2-mercaptopropionic acid, the development of CO₂ due to the decomposition of the methyl carbonate anion is noted.

At the end of the addition, stirring continues for a further 15 minutes, then the methanol is evaporated in a rotavapor at reduced pressure (equal to 24 torr) to obtain 100 g of pure 1-butyl-3-methylimidazolium 2-mercaptopropionate, as a colourless liquid, with a yield equal to 99% of the theoretical yield.

### Example 3

Synthesis of Ionic Liquid (B) Consisting of N-decylpyridinium and thiosalicylate

47.6 g of sodium thiosalicylate (0.27 moles) is loaded into a 1-litre glass flask to which 250 ml of water is added and shaken until completely dissolved.

To this solution, 68.5 g of N-decylpyridinium chloride (0.27 moles) is added, the salt dissolves and after a short time there is phase separation of a light-yellow liquid as the lower phase consisting of N-decylpyridinium thiosalicylate.

The working temperature is room temperature, around 20-25° C. The working pressure is atmospheric.

The contents of the flask are poured into a separating funnel to separate the yellow liquid, and once separated, it is dried with an anhydrifying agent (anhydrous sodium sulphate), resulting in a yield of 99% of the theoretical yield.

### Example 4

Synthesis of Ionic Liquid (D) Consisting of 1-butyl-3-methylimidazolium (BMIM) and the Anion of 2-mercaptoacetic acid (thioglycolic)

81.5 g of 1-butyl-3-methylimidazolium chloride is loaded into a 1-litre glass flask and dissolved in 200 ml of anhydrous methanol; 53.3 g of potassium thioglycolate is added to this solution and stirring continues for 15 minutes.

The working temperature is room temperature, around 20-25° C. The working pressure is atmospheric.

Potassium chloride precipitates and it is separated by filtration, this obtaining a solution from which methanol is evaporated in rotavapor at reduced pressure (equal to 24 torr).

A residue of 100 g of 1-butyl-3-methylimidazolium 2-mercaptoacetate is obtained as a clear, pale-yellow liquid with a yield of 99% of the theoretical yield.

### Example 5

Synthesis of Ionic Liquid (G) Consisting of 1-butyl-3-methylimidazolium (BMIM) and 3-mercaptopropionate

308.2 g of a 28.45 wt % solution in methanol of 1-butyl-3-methylimidazolium methylcarbonate equal to 87.7 g of pure 1-butyl-3-methylimidazolium methylcarbonate (0.409 moles) is loaded into a 1-litre glass flask, to which 43.4 g of 3-mercaptopropionic acid (0.409 moles) is added.

The working temperature is room temperature, around 20-25° C. The working pressure is atmospheric.

During the addition of 3-mercaptopropionic acid, the development of CO₂ due to the decomposition of the methylcarbonate anion is noted.

At the end of the addition, stirring continues for a further 15 minutes, then the methanol is evaporated in a rotavapor at reduced pressure and equal to 24 torr to obtain 100 g of pure 1-butyl-3-methylimidazolium 3-mercaptopropionate as a colourless liquid, with a yield equal to 99% of the theoretical yield.

### Example 6

Synthesis of Ionic Liquid (E) Consisting of 1-butyl-3-methylimidazolium (BMIM) and 3-mercaptobenzoate

257.6 g of a 28.45 wt % solution in methanol of 1-butyl-3-methylimidazolium methylcarbonate equal to 73.3 g of pure 1-butyl-3-methylimidazolium methylcarbonate (0.342 moles) is loaded into a 1-litre glass flask, to which 52.7 g of 3-mercaptobenzoic acid (0.342 moles) is added.

The working temperature is room temperature, around 20-25° C. The working pressure is atmospheric.

During the addition of 3-mercaptobenzoic acid, the development of CO₂ due to the decomposition of the methylcarbonate anion is noted.

At the end of the addition, stirring continues for a further 15 minutes, then the methanol is evaporated in a rotavapor at reduced pressure (equal to 24 torr) to obtain 100 g of pure 1-butyl-3-methylimidazolium 3-mercaptobenzoate as a colourless liquid, with a yield equal to 99% of the theoretical yield.

### Example 7

Synthesis of Ionic Liquid (F) Consisting of 1-butyl-3-methylimidazolium (BMIM) and 4-mercaptobenzoate

257.6 g of a 28.45 wt % solution in methanol of 1-butyl-3-methylimidazolium methylcarbonate equal to 73.3 g of pure 1-butyl-3-methylimidazolium methylcarbonate (0.342 moles) is loaded into a 1-litre glass flask, to which 52.7 g of 4-mercaptobenzoic acid (0.342 moles) is added.

The working temperature is room temperature, around 20-25° C. The working pressure is atmospheric.

During the addition of 3-mercaptobenzoic acid, the development of CO₂ due to the decomposition of the methylcarbonate anion is noted.

At the end of the addition, stirring continues for a further 15 minutes, then the methanol is evaporated in a rotavapor at reduced pressure (equal to 24 torr) to obtain 100 g of pure 1-butyl-3-methylimidazolium 4-mercaptobenzoate as a colourless liquid, with a yield equal to 99% of the theoretical yield.

### Examples 8-19: Elemental Sulfur Dissolution Test at Ambient Pressure

### Example 8

Sulfur Dissolution Test with Ionic Liquid (C) Consisting of 1-butyl-3-methylimidazolium and thiosalicylate Prepared in Example 1

A 250 ml glass flask is filled with 100 g of ionic liquid prepared as described in Example 1; the flask is immersed in a thermostatic oil bath (silicone oil) and heated to 80° C.

The flask can also be warmed up with a thermal cap, without thereby departing from the scope of the present disclosure.

Sulfur powder is then added, under agitation, until the solution is saturated, i.e. until the formation of deposit is visually observed.

Still under agitation, the addition operation is repeated by bringing the ionic liquid to 90° C., and after reaching saturation bringing it to 100° C. and saturating it with sulfur, then bringing it to 120° C. and saturating it with sulfur.

The ionic liquid always remains a clear solution.

In the attached table, the quantities of sulfur dissolved by the ionic liquid are expressed as weight percentages of sulfur at different temperatures and are obtained by dividing the total grams of sulfur dissolved in the ionic liquid by the total grams of ionic liquid used.

| | Sulfur | Sulfur | Sulfur | Sulfur |
|---|---|---|---|---|
| | dissolved | dissolved | dissolved | dissolved |
| | at 80° C. | at 90° C. | at 100° C. | at 120° C. |
| Ionic liquid | (wt %) | (wt %) | (wt %) | (wt %) |
| BMIM | 17 | 25 | 28 | 40 |
| thiosalicylate | | | | |

### Example 9

Sulfur Dissolution Test with Ionic Liquid (A) Consisting of 1-butyl-3-methylimidazolium and 2-mercaptopropionate Prepared in Example 2

A 250 ml glass flask is filled with 100 g of ionic liquid prepared as described in Example 2; the flask is immersed in a thermostatic oil bath (silicone oil) and heated to 80° C.

Sulfur powder is then added, under agitation, until the solution is saturated.

Still under agitation, the operation is repeated by bringing the ionic liquid to 90° C. and after reaching saturation, bringing it to 100° C. and saturating it with sulfur.

In the attached table, the quantities expressed as weight percentages of sulfur dissolved by the ionic liquid, at different temperatures, are obtained by dividing the total grams of sulfur dissolved in the ionic liquid by the total grams of ionic liquid used.

The ionic liquid always remains a clear solution.

| | Sulfur | Sulfur | Sulfur | Sulfur |
|---|---|---|---|---|
| | dissolved | dissolved | dissolved | dissolved |
| | at 40° C. | at 80° C. | at 90° C. | at 100° C. |
| Ionic liquid | (wt %) | (wt %) | (wt %) | (wt %) |
| BMIM and 2- | 30 | 65 | 95 | 105 |
| mercaptopropionate | | | | |

### Example 10

Sulfur Dissolution Test with Ionic Liquid (B) Consisting of N-decylpyridinium and thiosalicylate Prepared in Example 3

A 250 ml glass flask is filled with 100 g of ionic liquid prepared as described in Example 3; the flask is immersed in a thermostatic oil bath (silicone oil) and heated to 80° C.

Sulfur powder is then added, under agitation, until the solution is saturated.

Still under agitation, the addition operation is repeated by bringing the ionic liquid to 90° C., and after reaching saturation bringing it to 100° C. and saturating it with sulfur, then bringing it to 120° C. and saturating it with sulfur.

In the attached table, the quantities expressed as weight percentages of sulfur dissolved by the ionic liquid, at different temperatures, are obtained by dividing the total grams of sulfur dissolved in the ionic liquid by the total grams of ionic liquid used.

The ionic liquid always remains a clear solution.

| | Sulfur | Sulfur | Sulfur | Sulfur |
|---|---|---|---|---|
| | dissolved | dissolved | dissolved | dissolved |
| | at 80° C. | at 90° C. | at 100° C. | at 120° C. |
| Ionic liquid | (wt %) | (wt %) | (wt %) | (wt %) |
| N-decylpyridinium and | 22 | 28 | 30 | 33 |
| thiosalicylate | | | | |

### Example 11

Sulfur Dissolution Test with Ionic Liquid (D) Consisting of BMIM and the Anion of 2-mercaptoacetic acid Prepared in Example 4

A 250 ml glass flask is filled with 100 g of ionic liquid prepared as described in Example 4; the flask is immersed in a thermostatic oil bath (silicone oil) and heated to 80° C.

Sulfur powder is then added, under agitation, until the solution is saturated.

Still under agitation, the addition operation is repeated by bringing the ionic liquid to 90° C., and after reaching saturation bringing it to 100° C. and saturating it with sulfur, then bringing it to 120° C. and saturating it with sulfur.

In the attached table, the quantities expressed as weight percentages of sulfur dissolved by the ionic liquid, at different temperatures, are obtained by dividing the total grams of sulfur dissolved in the ionic liquid by the total grams of ionic liquid used.

The ionic liquid always remains a clear solution.

| | Sulfur | Sulfur | Sulfur | Sulfur |
|---|---|---|---|---|
| | dissolved | dissolved | dissolved | dissolved |
| | at 80° C. | at 90° C. | at 100° C. | at 120° C. |
| Ionic liquid | (wt %) | (wt %) | (wt %) | (wt %) |
| 1-butyl-3- | 80 | 95 | 105 | 110 |
| methylimidazolium | | | | |
| (BMIM) and anion of 2- | | | | |
| mercaptoacetic acid | | | | |

### Example 12

Sulfur Dissolution Test with Ionic Liquid (G) Consisting of 1-butyl-3-methylimidazolium and 3-mercaptopropionate Prepared in Example 5

A 250 ml glass flask is filled with 100 g of ionic liquid prepared as described in Example 5; the flask is immersed in a thermostatic oil bath (silicone oil) and heated to 80° C.

Sulfur powder is then added, under agitation, until the solution is saturated.

Still under agitation, the addition operation is repeated by bringing the ionic liquid to 90° C. and after reaching saturation, bringing it to 100° C. and saturating it with sulfur.

In the attached table, the quantities expressed as weight percentages of sulfur dissolved by the ionic liquid, at different temperatures, are obtained by dividing the total grams of sulfur dissolved in the ionic liquid by the total grams of ionic liquid used.

The ionic liquid always remains a clear solution.

| | Sulfur | Sulfur | Sulfur |
|---|---|---|---|
| | dissolved | dissolved | dissolved |
| | at 80° C. | at 100° C. | at 110° C. |
| Ionic liquid | (wt %) | (wt %) | (wt %) |
| BMIM and 3- | 60 | 72 | 74 |
| mercaptopropionate | | | |

### Example 13

Sulfur Dissolution Test with Ionic Liquid (E) Consisting of 1-butyl-3-methylimidazolium and 3-mercaptobenzoate Prepared in Example 6

A 250 ml glass flask is filled with 100 g of ionic liquid prepared as described in Example 6; the flask is immersed in a thermostatic oil bath (silicone oil) and heated to 80° C.

Sulfur powder is then added, under agitation, until the solution is saturated.

Still under agitation, the addition operation is repeated by bringing the ionic liquid to 90° C. and after reaching saturation, bringing it to 100° C. and saturating it with sulfur.

In the attached table, the quantities expressed as weight percentages of sulfur dissolved by the ionic liquid, at different temperatures, are obtained by dividing the total grams of sulfur dissolved in the ionic liquid by the total grams of ionic liquid used.

The ionic liquid always remains a clear solution.

| | Sulfur | Sulfur | Sulfur |
|---|---|---|---|
| | dissolved | dissolved | dissolved |
| | at 80° C. | at 90° C. | at 100° C. |
| Ionic liquid | (wt %) | (wt %) | (wt %) |
| BMIM and 3- | 35 | 45 | 55 |
| mercaptobenzoate | | | |

### Example 14

Sulfur Dissolution Test with Ionic Liquid (F) Consisting of 1-butyl-3-methylimidazolium and 4-mercaptobenzoate Prepared in Example 7

A 250 ml glass flask is filled with 100 g of ionic liquid prepared as described in Example 7; the flask is immersed in a thermostatic oil bath (silicone oil) and heated to 80° C.

Sulfur powder is then added, under agitation, until the solution is saturated.

Still under agitation, the addition operation is repeated by bringing the ionic liquid to 90° C. and after reaching saturation, bringing it to 110° C. and saturating it with sulfur.

In the attached table, the quantities expressed as weight percentages of sulfur dissolved by the ionic liquid, at different temperatures, are obtained by dividing the total grams of sulfur dissolved in the ionic liquid by the total grams of ionic liquid used.

The ionic liquid always remains a clear solution.

| | Sulfur | Sulfur | Sulfur |
|---|---|---|---|
| | dissolved | dissolved | dissolved |
| | at 80° C. | at 90° C. | at 100° C. |
| Ionic liquid | (wt %) | (wt %) | (wt %) |
| BMIM and 4- | 5 | 10 | 14 |
| mercaptobenzoate | | | |

### Example 15

Sulfur Dissolution Test with Ionic Liquid (A) Consisting of 1-butyl-3-methylimidazolium and 2-mercaptopropionate (Example 2) and Mixed with 1,3-dimethyl-2-imidazolidinone (DMI)

A 250 ml glass flask is filled with 50 g of ionic liquid prepared as described in Example 2, to which 50 g of 1,3-dimethyl-2-imidazolidinone (DMI) is added to obtain a clear solution; the flask is immersed in a thermostatic oil bath (silicone oil) and heated to 90° C., as in the other examples.

Sulfur powder is then added, under agitation, until the solution is saturated.

In the attached table, the quantities expressed as weight percentages of sulfur dissolved by the ionic liquid, at different temperatures, are obtained by dividing the total grams of sulfur dissolved in the ionic liquid by the total grams of ionic liquid used.

The ionic liquid always remains a clear solution.

| | Sulfur |
|---|---|
| | dissolved |
| | at 90° C. |
| Ionic liquid | (wt %) |
| BMIM and 2- | 65 |
| mercaptopropionate + DMI | |

Comparing the solubility data in the table above with the solubility data in Example 9, it can be seen that at the same temperature (90° C.), the pure ionic liquid dissolves 95 wt % of sulfur, whereas a solvent composition containing 50 wt % of the same ionic liquid dissolves 65 wt % of sulfur.

This is unexpected as one would have expected a value of about 47.5%, i.e. half of 95%, given the use of half the amount of ionic liquid, instead of 65% which is a considerably higher value than 47.5%.

This shows that the presence of aprotic polar solvent results in an unexpected synergistic effect in the solubilisation of sulfur, particularly in light of the fact that the aprotic polar solvent used in the example is not used in the art as a dissolution solvent for elemental sulfur.

### Example 16

Sulfur Dissolution Test with Ionic Liquid (A) Consisting of 1-butyl-3-methylimidazolium and 2-mercaptopropionate (Example 2) and Mixed with sulfolane

A 250 ml glass flask is filled with 50 g of ionic liquid prepared as described in Example 2, to which 50 g of sulfolane is added to obtain a clear solution; the flask is immersed in a thermostatic oil bath (silicone oil) and heated to 90° C.

Sulfur powder is then added, under agitation, until the solution is saturated.

Still under agitation, the addition operation is repeated, thus bringing the ionic liquid to 100° C.

In the attached table, the quantities expressed as weight percentages of sulfur dissolved by the ionic liquid, at different temperatures, are obtained by dividing the total grams of sulfur dissolved in the ionic liquid by the total grams of ionic liquid used.

The ionic liquid always remains a clear solution.

| | Sulfur | Sulfur |
|---|---|---|
| | dissolved | dissolved |
| | at 90° C. | at 100° C. |
| Ionic liquid | (wt %) | (wt %) |
| BMIM and 2- | 50 | 75 |
| mercaptopropionate + | | |
| sulfolane | | |

Comparing the solubility data in the above table with those given in Example 9, it can be seen that at the same temperature of 100° C., the pure ionic liquid of the disclosure dissolves 105 wt % of sulfur, whereas a solvent composition containing 50 wt % of the same ionic liquid and 50 wt % of aprotic polar solvent dissolves 75 wt % of sulfur.

This is unexpected as one would have expected a value of about 52.5%, i.e. half of 105%, given the use of half the amount of ionic liquid, instead of 75 wt % which is a considerably higher value than 52.5%.

This shows that the presence of the polar aprotic solvent leads to an unexpected synergistic effect in sulfur solubilisation, particularly in light of the fact that sulfolane is not known to be a dissolution solvent for elemental sulfur.

### Example 17

Sulfur Dissolution Test from Real Sample with Ionic Liquid (D) Consisting of BMIM and the Anion of 2-mercaptoacetic Acid Prepared in Example 4 and Used in Example 11

A 250 ml glass flask is filled with 100 g of ionic liquid prepared as described in Example 4; the flask is immersed in a thermostatic oil bath (silicone oil) and heated to 80° C.

Under agitation, powdered sulfur obtained by grinding a sample of deposit that blocked a gas well in the United Arab Emirates is added until the solution is saturated.

The sample of deposit consisted of sulfur with a purity (measured by elemental analysis using a CHS-580 A analyser by Eltra) of 99.7% sulfur by weight and an organic content of 0.27% by weight (hydrocarbons, mainly aromatic).

Still under agitation, the addition of sulfur powder to the sample is repeated bringing the ionic liquid to 90° C. and after reaching saturation bringing it to 100° C. and saturating with sulfur, then bringing it to 120° C. and saturating it with sulfur.

In the attached table, the quantities expressed as weight percentages of sulfur dissolved by the ionic liquid, at different temperatures, are obtained by dividing the total grams of sulfur dissolved in the ionic liquid by the total grams of ionic liquid used.

The ionic liquid always remains a clear solution.

| | Sulfur | Sulfur | Sulfur | Sulfur |
|---|---|---|---|---|
| | dissolved | dissolved | dissolved | dissolved |
| | at 80° C. | at 90° C. | at 100° C. | at 120° C. |
| Ionic liquid | (wt %) | (wt %) | (wt %) | (wt %) |
| 1-butyl-3- | 81 | 92 | 103 | 108 |
| methylimidazolium (BMIM) | | | | |
| and anion of 2- | | | | |
| mercaptoacetic acid | | | | |

Comparing the solubility data provided in the above table with those provided in Example 11, it can be stated that the solubility data of the real sulfur sample in the dissolving compositions of the present disclosure are substantially similar to those of pure elemental sulfur in the same compositions, with the same ionic liquid used.

### Example 18 (Comparative)

### Sulfur Dissolution Test in Toluene

100 ml toluene is loaded into a 250 ml glass flask, equipped with refrigerated reflux; the flask is immersed in a thermostatic oil bath (silicone oil) and heated to 80° C.

Sulfur powder is then added, under agitation, until the solution is saturated.

Still under agitation, the addition operation is repeated by bringing the ionic liquid to 90° C., and after reaching saturation bringing it to 100° C. and saturating it with sulfur, then bringing it to 110° C. (boiling point of toluene) and saturating it with sulfur.

In the attached table, the quantities expressed as weight percentages of sulfur dissolved by the ionic liquid, at different temperatures, are obtained by dividing the total grams of sulfur dissolved in the ionic liquid by the total grams of ionic liquid used.

The ionic liquid always remains a clear solution.

| | Sulfur | Sulfur | Sulfur | Sulfur |
|---|---|---|---|---|
| | dissolved | dissolved | dissolved | dissolved |
| | at 80° C. | at 90° C. | at 100° C. | at 110° C. |
| Solvent | (wt %) | (wt %) | (wt %) | (wt %) |
| toluene | 4.9 | 5.2 | 6.1 | 6.5 |

Comparing the data in the above table for toluene with the solubility data in Example 14 for a dissolving composition consisting of ionic liquid (F) according to the disclosure, it can be stated that
at 80° C., the ionic liquid (F) has essentially the same solubility as toluene;
above 80° C., as the temperature increases, the present ionic liquid (F) displays a greater increase in sulfur solubility than the increase in sulfur solubility in toluene.

### Example 19 (Comparative)

### Sulfur Dissolution Test in Sulfolane

Similar to comparative example 18, 100 g of sulfolane is loaded into a 250 ml glass flask; the flask is immersed in a thermostatic oil bath (silicone oil) and heated to 80° C.

Sulfur powder is then added, under agitation, in an amount equal to 2% by weight of the sulfolane: no solubilisation of the sulfur is observed, which remains a deposit.

Still under agitation, the temperature is raised to 90° C., but no solubilisation of the deposit is observed.

The operation of raising the temperature under agitation is repeated, thus bringing the contents of the flask to 100° C., 110° C. and 120° C.

At 120° C., the formation of a clear solution is observed, while with the addition of a further 1% by weight of sulfur to the weight of the solvent (3% total sulfur to solvent), the formation of a deposit is observed.

Therefore, sulfur is soluble in sulfolane up to 2% by weight at 120° C. At temperatures below 120° C., sulfur has a solubility in sulfolane of less than 2% by weight.

1. A dissolving composition capable of dissolving deposits formed mainly by elemental sulfur, which are present in a drilling and/or extraction well for natural gas, or for hydrocarbons in which a natural gas fraction is present as associated gas, said composition comprising a dissolution solvent of elemental sulfur, optionally in admixture with at least one aprotic polar solvent, wherein said dissolution solvent is an ionic compound, or a mixture of ionic compounds, each ionic compound consisting of
at least one anion, and
at least one cation
wherein said at least one anion comprises an aliphatic radical R and a carboxylate group (anion RCOO—) bonded to said aliphatic radical R,
said aliphatic radical R having a number of carbon atoms ranging from 1 to 26,
said aliphatic radical R also containing at least one thiol group —SH as a substituent of H atom or of a methyl group contained in said aliphatic radical R,
said at least one thiol group being in position 2, 3 or 4 with respect to the carboxylate group.

2. The composition according to claim 1, wherein said at least one thiol group of said at least one RCOO— anion is in position 2 with respect to the carboxylate group.

3. The composition according to claim 1, wherein said radical R of said at least one anion RCOO— is selected from aromatic group; alkylbenzene group containing one or more alkyl groups which are identical or different from each other, each containing from 1 to 10 carbon atoms (C1-C10); naphthalene group; alkylnaphthalene group containing one or more alkyl groups, identical or different from each other, each containing from 1 to 10 carbon atoms (C1-C10); alicyclic group containing from 4 to 15 carbon atoms; C1-C10 alkyl radical.

4. The composition according to claim 1, wherein said at least one anion RCOO— is selected from thiosalicylate, 2-mercaptopropionate, 3-mercaptopropionate, anion of 2-mercaptoacetic acid (thioglycolic), 3-mercaptobenzoate, 4-mercaptobenzoate anion.

5. The composition according to claim 1, wherein said at least one cation is a cation based on heterocyclic compounds, selected from compounds based on imidazolium, pyridinium, pyrazolium, thiazolium, isothiazolinium, azatiazolium, oxothiazolium, dithiazolium, triazolium, thiophenium, indolium, pyrimidinium, pyrazinium, pyridazinium, piperazinium, piperidinium, morpholinium, pyranium, pyrrolidinium compounds and the like.

6. The composition according to claim 1, wherein said at least one cation of said ionic compound is selected from 1-butyl-3-methylimidazolium (BMIM), N-decylpyridinium.

7. The composition according to claim 1, wherein said ionic compound is selected from the group formed by the following ionic liquids:
(A) 1-butyl-3-methylimidazolium (BMIM) in combination with 2-mercaptopropionate, of formula 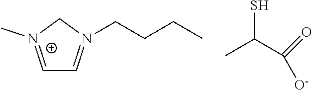
(B) N-decylpyridinium in combination with thiosalicylate, of formula 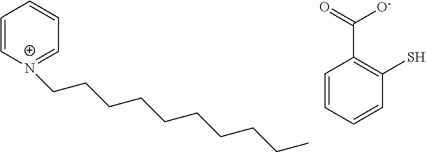 [SMILES: CCCCCCCCCC[n+]1ccccc1 ; O=C([O-])c1ccccc1S]
(C) 1-butyl-3-methylimidazolium (BMIM) in combination with thiosalicylate, of formula 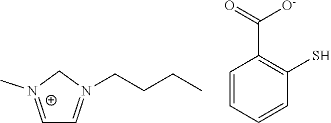
(D) 1-Butyl-3-methylimidazolium (BMIM) in combination with the anion of 2-mercaptoacetic acid (thioglycolic acid), of formula 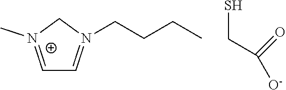
(E) 1-butyl-3-methylimidazolium (BMIM) in combination with 3-mercaptobenzoate, of formula 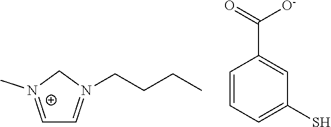
(F) 1-butyl-3-methylimidazolium (BMIM) in combination with 4-mercaptobenzoate 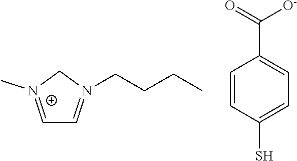
(G) 1-butyl-3-methylimidazolium (BMIM) and 3-mercaptopropionate 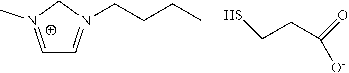
(H) one or more combinations of ionic liquids (A) to (G).

8. The composition according to claim 7, wherein said ionic compound is an ionic liquid selected from
ionic liquid (A) formed by BMIM (1-butyl-3-methylimidazolium) in combination with 2-mercaptopropionate;
ionic liquid (D) formed by BMIM in combination with the anion of 2-mercaptoacetic acid.

9. The composition according to claim 1 further comprising one or more polar aprotic solvents.

10. The composition according to claim 9, wherein the polar aprotic solvent is selected from the group consisting of dimethyl sulfoxide (DMSO), sulfolane, DMPU (1,3-dimethyl-3,4,5,6-tetrahydro-2(1H)-pyrimidinone), 3-butylmethylimidazolium-bistrifluorosulfonylimide or other imidazole salts of bistrifluorimide, tetrathiophene oxide and HMPA (hexamethylphosphoramide), or mixtures thereof, dihydrolevoglucosenone (Cyrene™), ethylene glycol protected ketone deriving from levoglucosenone (Cygnet0.0™), dimethyl-isosorbide or Methyl-5-(dimethylamino)-2-methyl-5-oxopentanoate (Polarclean™) or mixtures thereof.

11. The composition according to claim 9, wherein the content of ionic compound or mixture of ionic compounds ranges from 99.5% to 30% by weight, the remaining part by weight to 100 (70%−0.5%) being composed of said aprotic polar solvent or of said mixture of aprotic polar solvents.

12. A method of removing deposits, formed mainly by elemental sulfur, in a drilling and/or extraction well of a natural gas or of hydrocarbons wherein said natural gas is a fraction present as an associated gas, said method comprising
at least a step of dissolving said deposits by contacting with the dissolving composition as defined in claim 1.

13. The method according to claim 12, wherein contacting between said dissolving composition and said sulfur deposits in the dissolving step provides for
A) feeding said drilling and/or extraction well with said dissolving composition.

14. The method according to claim 13, wherein step A) of feeding of said dissolving composition is carried out until dissolution of said deposits.

15. The method according to claim 12, wherein after the dissolving step, further provided a step of
B) extracting said composition comprising, in dissolved form, deposits, formed mainly by elemental sulfur, from said well.

16. The method according to claim 15, wherein after step B) provided a step of
C) cooling down to room temperature said composition extracted in step B) comprising deposits, in dissolved form, formed mainly by elemental sulfur, so as to cause the precipitation of the elemental sulfur dissolved in said composition.

17. The method according to claim 15, wherein after said step B) or step C), further provided a subsequent step of
D) separating said elemental sulfur from said cooled composition in said step C) or from said composition extracted in said step B).

18. A method of preventing the precipitation of sulfur and/or the formation of deposits, formed mainly by elemental sulfur, in a drilling and/or extraction well for natural gas, or hydrocarbons in which said natural gas is a fraction present as an associated gas, said method comprising at least a step of
contacting, during the extraction of said natural gas or said hydrocarbons, one or more components of said well which are contained in said well or which form said well, with said dissolving composition as defined in claim 1.

19. The method of preventing according to claim 18, wherein said contacting step takes place by carrying out a continuous flushing of the internal and/or external surface of one or more of said components of said well by continuously injecting said dissolving composition, in a liquid form.

20. A process for preparing the dissolving composition as defined in claim 1, said process comprising a step for preparing said at least one ionic compound by a metathesis reaction in solvent between a first salt containing the cation of said ionic compound and a second salt containing the anion of said ionic compound.
